(19) United States
(12) Patent Application Publication
(10) Pub. No.: US 2025/0153570 A1
(43) Pub. Date: May 15, 2025

(54) VEHICLE

(71) Applicant: Panasonic Automotive Systems Co., Ltd., Kanagawa (JP)

(72) Inventors: Takashi YAMAO, Osaka (JP); Satoshi TSUCHIYA, Tokyo (JP)

(73) Assignee: Panasonic Automotive Systems Co., Ltd., Kanagawa (JP)

(21) Appl. No.: 19/023,825

(22) Filed: Jan. 16, 2025

Related U.S. Application Data
(63) Continuation of application No. PCT/JP2023/032043, filed on Aug. 31, 2023.

(30) Foreign Application Priority Data
Nov. 30, 2022 (JP) 2022-191768
Nov. 30, 2022 (JP) 2022-191769
Mar. 24, 2023 (JP) 2023-048200
Mar. 24, 2023 (JP) 2023-048201
Mar. 24, 2023 (JP) 2023-048202

(51) Int. Cl. B60K 35/81; B60K 35/22; B60K 35/28; B60K 35/29; B60K 35/65

(52) U.S. Cl. CPC B60K 35/81; B60K 35/22; B60K 35/28; B60K 35/29; B60K 35/656; B60K 2360/28; B60K 2360/349

(57) ABSTRACT

A vehicle includes a transparent display having a variable transmittance disposed between a rear seat and a front seat. The transparent display plays predetermined video content. The predetermined video content has at least a first phase, a second phase that follows the first phase, a third phase that follows the second phase, and a fourth phase that follows the third phase. At a beginning of the first phase, the variable transmittance of the transparent display is a first transmittance, and at an end of the first phase, the variable transmittance of the transparent display is a second transmittance that is smaller than the first transmittance.

### TECHNICAL FIELD

The present disclosure relates to a vehicle.

### BACKGROUND ART

In the related art, a display device having a variable light transmittance is known. For example, Patent Literature 1 discloses that a display device provided in a vehicle cabin includes a transparent display that displays an information image on a display surface through which light can transmit, and a light-shielding display that displays a light-shielding image whose light transmittance can be adjusted, and the display device acquires an intensity of a direct light toward the transparent display, and adjusts a transmittance of the light-shielding image to be lower as the direct light becomes stronger.

### CITATION LIST

### Patent Literature

Patent Literature 1: JP2020-79917A

### SUMMARY OF INVENTION

For example, a person sitting in a rear seat of a vehicle may want to take a temporary rest to recover from mental and physical fatigue. However, the rear seat of the vehicle in the related art is not designed for a purpose of recovering from mental and physical fatigue.

An object of the present disclosure is to provide a technique for supporting recovery from mental and physical fatigue of a person sitting in a rear seat of a vehicle.

An aspect of the present disclosure provides a vehicle including: at least
a vehicle body;
a first wheel coupled to the vehicle body;
   a second wheel coupled to the vehicle body;
   a third wheel coupled to the vehicle body; and
   a fourth wheel coupled to the vehicle body; and
   the vehicle being capable of traveling in a predetermined direction using the first wheel, the second wheel, the third wheel, and the fourth wheel, in which
   the vehicle body includes
      a floor surface portion and a ceiling surface portion disposed along the predetermined direction,
      a left side surface portion that connects the floor surface portion and the ceiling surface portion and is disposed on a left side surface along the predetermined direction,
      a right side surface portion that connects the floor surface portion and the ceiling surface portion and is disposed on a right side surface along the predetermined direction,
      a front surface portion that connects the floor surface portion and the ceiling surface portion and is disposed on a front portion with respect to the predetermined direction,
      a rear surface portion that connects the floor surface portion and the ceiling surface portion and is disposed on a rear portion with respect to the predetermined direction,
      at least one front seat disposed on the floor surface portion, closer to the front surface portion than the rear surface portion, and
      at least one rear seat disposed on the floor surface portion, closer to the rear surface portion than the front surface portion,
   the front surface portion includes a glass that allows an outside of the vehicle to be viewed in the predetermined direction from the front seat,
   the vehicle body further includes a transparent display having a variable transmittance between the rear seat and the front seat,
   the outside of the vehicle is visible from the rear seat through the transparent display and the glass,
   the transparent display is set to play predetermined video content,
   the predetermined video content has at least a first phase, a second phase that follows the first phase, a third phase that follows the second phase, and a fourth phase that follows the third phase,
   at a beginning of the first phase, the variable transmittance of the transparent display is a first transmittance, and
   at an end of the first phase, the variable transmittance of the transparent display is a second transmittance that is smaller than the first transmittance.

These comprehensive or specific aspects may be implemented by a system, a device, a method, an integrated circuit, a computer program, or a recording medium, or any combination of the system, the device, the method, the integrated circuit, the computer program, and the recording medium.

According to the present disclosure, recovery from mental and physical fatigue of a person sitting in a rear seat of a vehicle can be supported.

### BRIEF DESCRIPTION OF DRAWINGS

FIG. 1 is a plan view illustrating a configuration example of a vehicle according to Embodiment 1, as seen through a vehicle interior from above;

FIG. 2 is a side view illustrating the configuration example of the vehicle according to Embodiment 1, as seen through the vehicle interior from the side;

FIG. 3 is a diagram illustrating the configuration example of the vehicle according to Embodiment 1, as seen forward from a rear seat in the vehicle interior;

FIG. 4 is a block diagram illustrating a configuration example of a fatigue recovery support system according to Embodiment 1;

FIG. 5 is a graph illustrating an example of a change in transmittance of a transparent display in each phase according to Embodiment 1;

FIG. 6 is a diagram illustrating a first example of video content displayed on the transparent display in a first phase according to Embodiment 1;

FIG. 7 is a diagram illustrating a second example of the video content displayed on the transparent display in the first phase according to Embodiment 1;

FIG. 8 is a diagram illustrating a first example of video content displayed on the transparent display in a third phase according to Embodiment 1;

FIG. 9 is a diagram illustrating a second example of the video content displayed on the transparent display in the third phase according to Embodiment 1;

FIG. 10 is a diagram illustrating an example of video content displayed on a transparent display in a first phase in a case in which a light control film is provided on a rear door window according to Embodiment 2;

FIG. 11 is a diagram illustrating an example of video content displayed on the transparent display in the first phase in a case in which a light-shielding curtain is provided on the rear door window according to Embodiment 2; and

FIG. 12 is a diagram for explaining a time interval for scene switching in a third phase according to Embodiment 2.

### DESCRIPTION OF EMBODIMENTS

Hereinafter, embodiments of the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

### Embodiment 1

### <Configuration of Vehicle>

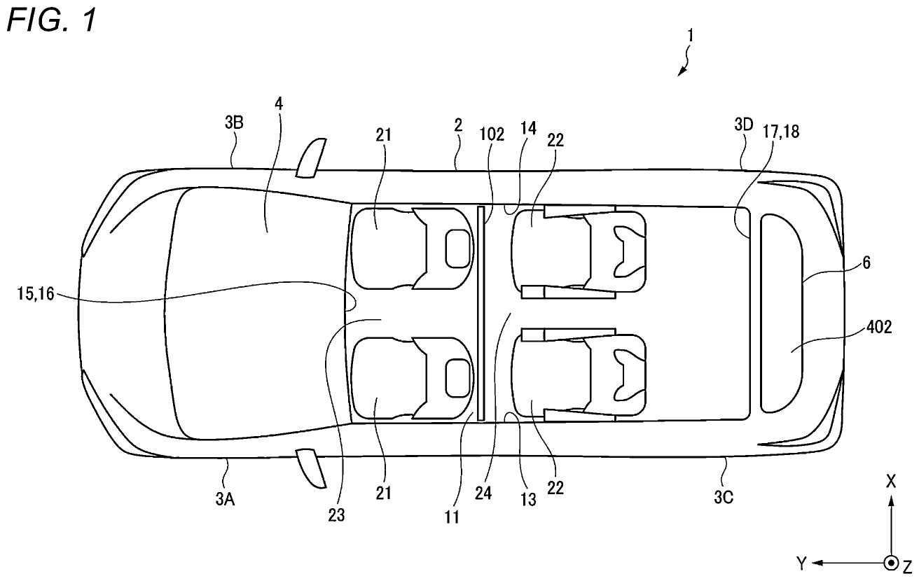

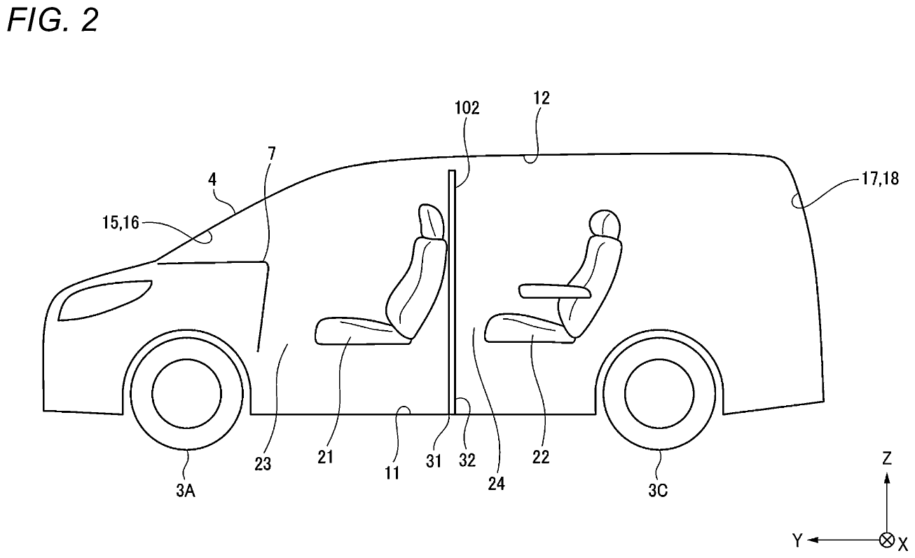

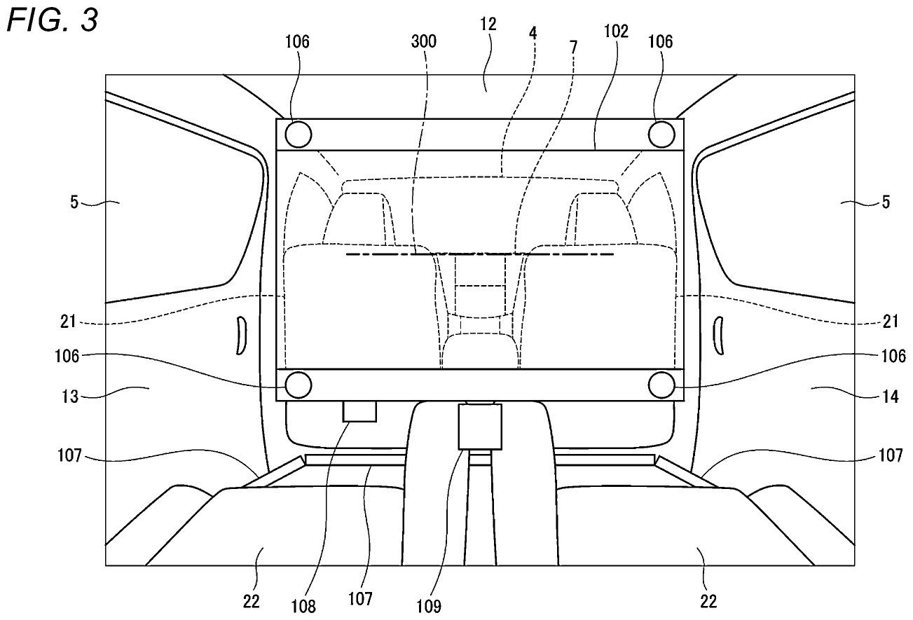

FIG. 1 is a plan view illustrating a configuration example of a vehicle 1 according to Embodiment 1, as seen through a vehicle interior from above. FIG. 2 is a side view illustrating the configuration example of the vehicle 1 according to Embodiment 1, as seen through the vehicle interior from the side. FIG. 3 is a diagram illustrating the configuration example of the vehicle 1 according to Embodiment 1, as seen forward from a rear seat 22 in the vehicle interior. Next, the configuration of the vehicle 1 will be described with reference to FIGS. 1, 2, and 3.

For convenience of description, as illustrated in FIGS. 1 and 2, an entire length direction of the vehicle 1 is defined as a Y axis, a width direction of the vehicle 1 is defined as an X axis, and a height direction of the vehicle 1 is defined as a Z axis. For convenience of description, a positive direction of the Z axis may be referred to as “upper”, a negative direction of the Z axis may be referred to as “lower”, a positive direction of the Y axis may be referred to as “front”, a negative direction of the Y axis may be referred to as “rear”, a positive direction of the X axis may be referred to as “right”, and a negative direction of the X axis may be referred to as “left”. The expressions related to these directions are used for convenience of explanation, and are not intended to limit a posture of the structure in actual use.

The vehicle 1 includes at least a vehicle body 2 and a first wheel 3A, a second wheel 3B, a third wheel 3C, and a fourth wheel 3D connected to the vehicle body 2, and is capable of traveling in a predetermined direction (for example, a direction of the Y axis) using the first wheel 3A, the second wheel 3B, the third wheel 3C, and the fourth wheel 3D. However, the vehicle 1 is not limited to the configuration including four wheels, and may be a configuration including two or three wheels or five or more wheels. The vehicle 1 may be a private car, a commercial car, a taxi, a truck, a bus, or the like.

The vehicle body 2 includes a floor surface portion 11 and a ceiling surface portion 12 disposed along the predetermined direction.

The vehicle body 2 includes a left side surface portion 13 that connects the floor surface portion 11 and the ceiling surface portion 12 and is disposed on a left side surface along the predetermined direction, and a right side surface portion 14 that connects the floor surface portion 11 and the ceiling surface portion 12 and is disposed on a right side surface along the predetermined direction.

The vehicle body 2 includes a front surface portion 16 that connects the floor surface portion 11 and the ceiling surface portion 12 and is disposed in a front portion 15 with respect to the predetermined direction, and a rear surface portion 18 that connects the floor surface portion 11 and the ceiling surface portion 12 and is disposed in a rear portion 17 with respect to the predetermined direction.

The vehicle body 2 includes at least one front seat 21 disposed on the floor surface portion 11, closer to the front surface portion 16 than the rear surface portion 18, and at least one rear seat 22 disposed on the floor surface portion 11, closer to the rear surface portion 18 than the front surface portion 16.

The front surface portion 16 includes a front window 4 made of glass that allows an outside of the vehicle to be viewed from the front seat 21 in the predetermined direction.

The vehicle body 2 further includes a rectangular transparent display 102 between the rear seat 22 and the front seat 21. The transparent display 102 is provided such that a longitudinal direction of the rectangle is along a horizontal direction (X axis direction). The transparent display 102 includes at least a self-emissive display 103 and a light control film 104 whose light transmittance is variable. The light control film may be interpreted as a sheet. In the following, for ease of understanding, it may be expressed as changing a transmittance of the transparent display 102, and this may be interpreted as changing the transmittance of the light control film 104. Examples of the self-emissive display 103 include an organic EL display, an LED display, or the like.

A user sitting in the rear seat 22 can view the outside of the vehicle through the transparent display 102 and the front window 4.

The transparent display 102 is set to play predetermined video content. In this embodiment, the video content will be described as a moving image, and the video content may be a still image. Details of the video content will be described later.

The vehicle 1 includes a front chamber 23 in which the front seat 21 is disposed, and a rear chamber 24 in which the rear seat 22 is disposed. The vehicle 1 further includes a partition wall 31 that is provided to partition the front chamber 23 and the rear chamber 24 and on which the transparent display 102 is disposed.

The vehicle 1 includes a light-emitting unit 107 in the vehicle interior, which can adjust a light color and a light intensity. The light-emitting unit 107 is disposed on at least one of a partition wall rear chamber side surface portion 32 of the partition wall 31 on a rear chamber 24 side, the floor surface portion 11 in contact with the rear chamber 24, the ceiling surface portion 12 in contact with the rear chamber 24, the rear surface portion 18 in contact with the rear chamber 24, the left side surface portion 13 in contact with the rear chamber 24, and the right side surface portion 14 in contact with the rear chamber 24. FIG. 3 illustrates a portion of the light-emitting unit 107. An example of the light-emitting unit 107 is a light emitting diode (LED) light.

The vehicle 1 includes an aroma generation unit 108 that generates an aroma. The aroma generation unit 108 is provided, for example, in the rear chamber 24. An example of the aroma generation unit 108 is an aroma diffuser. The aroma generated by the aroma generation unit 108 will be described later in detail.

The vehicle 1 includes speakers 106 in the rear chamber 24 in the vehicle interior. As illustrated in FIG. 3, the speakers 106 may be provided at each of an upper portion and a lower portion of the transparent display 102. Further, the speakers 106 may also be provided in the rear seat 22 (not illustrated). At least some of the provided speakers 106 (for example, the speaker 106 provided in the rear seat 22) may be tweeters. At least some of the provided speakers 106 may be woofers.

The vehicle 1 includes an operation unit 109 near the rear seat 22 in the vehicle interior. The operation unit 109 may be a tablet terminal provided in the vehicle interior. Alternatively, the operation unit 109 may connect a smartphone carried by the user to the vehicle 1 in a wired or wireless manner. Details of operations that the user can perform through the operation unit 109 will be described later.

### <System Configuration>

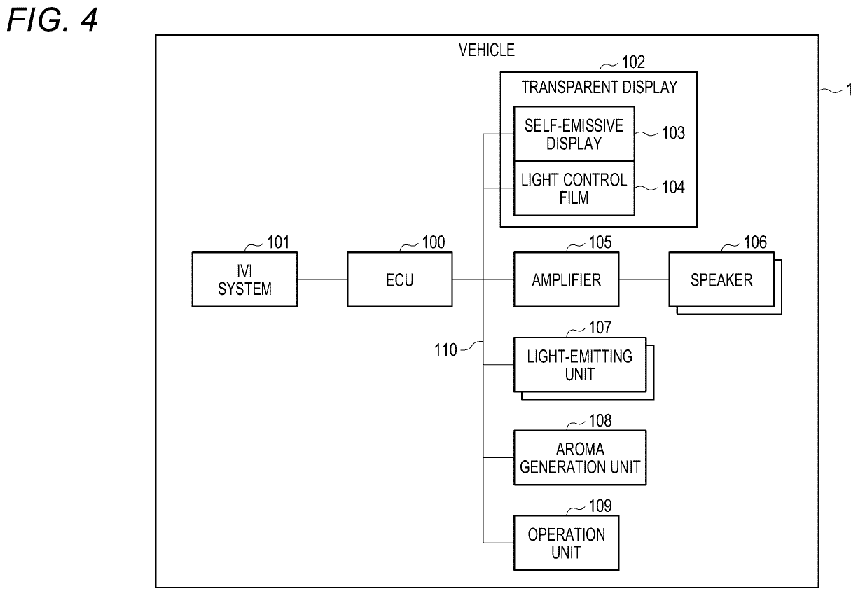

FIG. 4 is a block diagram illustrating a configuration example of a fatigue recovery support system according to Embodiment 1.

The fatigue recovery support system according to Embodiment 1, which is mounted on the vehicle 1, includes an ECU 100, an IVI system 101, the transparent display 102, the self-emissive display 103, the light control film 104, an amplifier 105, the speaker 106, the light-emitting unit 107, the aroma generation unit 108, and the operation unit 109. The ECU is an abbreviation for an electronic control unit. These can transmit and receive information via, for example, a vehicle network 110. Examples of the vehicle network 110 include a controller area network (CAN), LIN, FlexRay, and the like.

The transparent display 102, the self-emissive display 103, the light control film 104, the speaker 106, the light-emitting unit 107, the aroma generation unit 108, and the operation unit 109 have been described above, and thus description thereof is omitted here.

The amplifier 105 amplifies a sound signal output from the speaker 106. The amplifier 105 may be compatible with high resolution. This allows higher quality sound to be output from the speaker 106.

The IVI is an abbreviation for “in-vehicle infotainment”, and the infotainment is a coined word obtained by combining information and entertainment. The IVI system 101 is a system that provides information and entertainment to a passenger from an electronic device mounted on the vehicle 1.

The ECU 100 receives information from the IVI system 101 and transmits a command to the IVI system 101 via the vehicle network 110. The ECU 100 mounted on the vehicle 1 is not limited to one ECU, and a plurality of ECUs 100 may be provided.

The ECU 100 may include a non-volatile memory. The memory may store video content. The memory may store content related to sound output from the speaker 106 in conjunction with the video content (hereinafter, referred to as sound content). The memory may store content for changing the light transmittance of the light control film 104 in conjunction with the video content (hereinafter, referred to as light control content). The memory may store content for causing the light-emitting unit 107 to emit light in conjunction with the video content (hereinafter, referred to as light emission content). The memory may store content for generating an aroma from the aroma generation unit 108 in conjunction with the video content (hereinafter, referred to as aroma content). The content may be stored in the memory in advance. The content may be updated as appropriate.

The ECU 100 performs processing of playing video content and displaying the video content on the transparent display 102. The ECU 100 performs processing of transmitting the sound content to the amplifier 105 and outputting the sound content from the speaker 106 in conjunction with the playing of the video content. The ECU 100 performs processing of changing the transmittance of the transparent display 102 based on the light control content in conjunction with the playing of the video content. The ECU 100 performs processing of changing the light color and/or the light intensity of the light-emitting unit 107 based on the light emission content in conjunction with the playing of the video content. The ECU 100 performs processing of changing, based on the aroma content, whether to generate an aroma from the aroma generation unit 108, a type of the aroma to be generated, and/or an intensity of the aroma to be generated, in conjunction with the playing of the video content.

The ECU 100 receives information indicating operation contents (hereinafter, referred to as operation information) from the operation unit 109, and controls, based on the operation information, at least one of the transparent display 102, the light control film 104, the amplifier 105, the light-emitting unit 107, and the aroma generation unit 108. For example, the ECU 100 starts or stops playing of the video content by controlling the transparent display 102 based on the operation information. For example, the ECU 100 adjusts volume of the sound content by controlling the amplifier 105 based on the operation information. For example, the ECU 100 adjusts a maximum value and/or a minimum value of the transmittance by controlling the light control film 104 based on the operation information. For example, the ECU 100 sets whether the light-emitting unit 107 is permitted to emit light, adjusts an amount of the light, and the like by controlling the light-emitting unit 107 based on the operation information. For example, the ECU 100 sets whether the aroma generation unit 108 is permitted to generate an aroma and sets an intensity of the aroma (for example, airflow volume for sending the aroma) by controlling the aroma generation unit 108 based on the operation information. The ECU 100 may be interpreted as other terms such as a processor, a controller, a control unit, or a control circuit.

### <Processing for Fatigue Recovery Support>

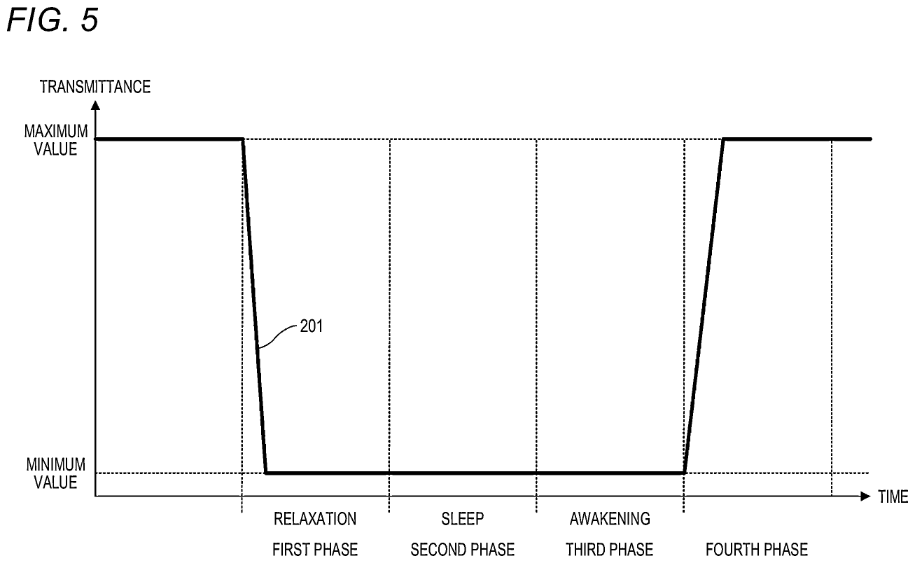

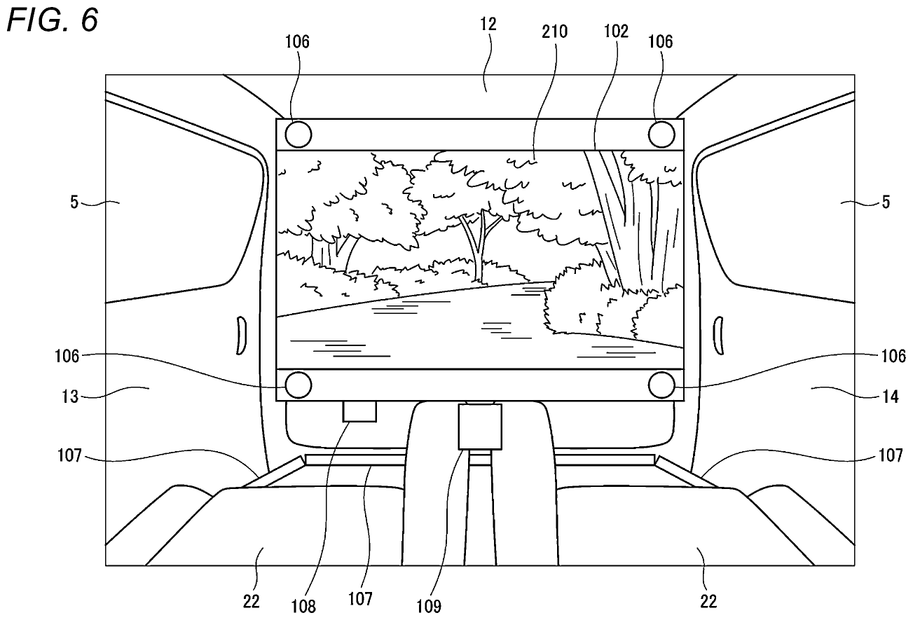

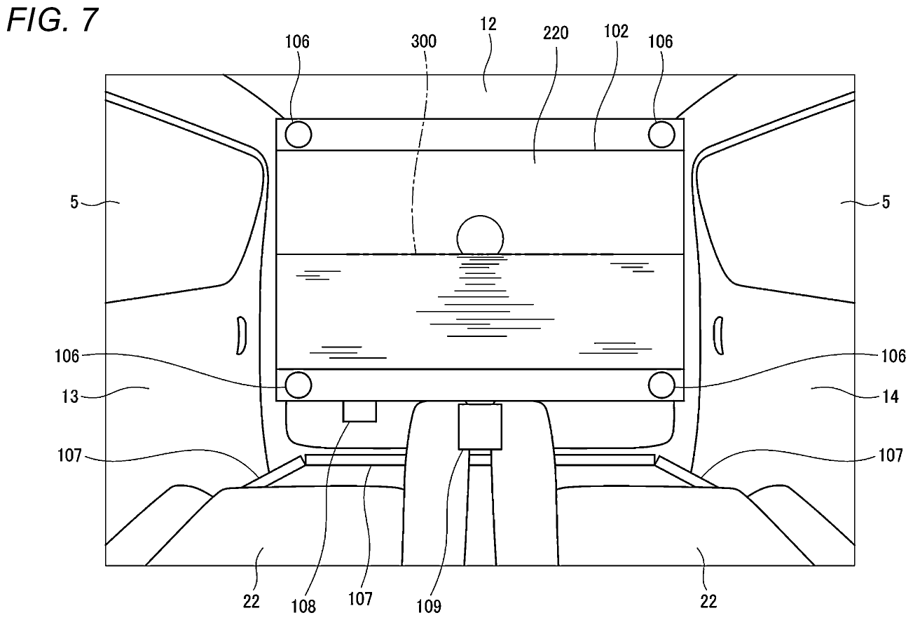

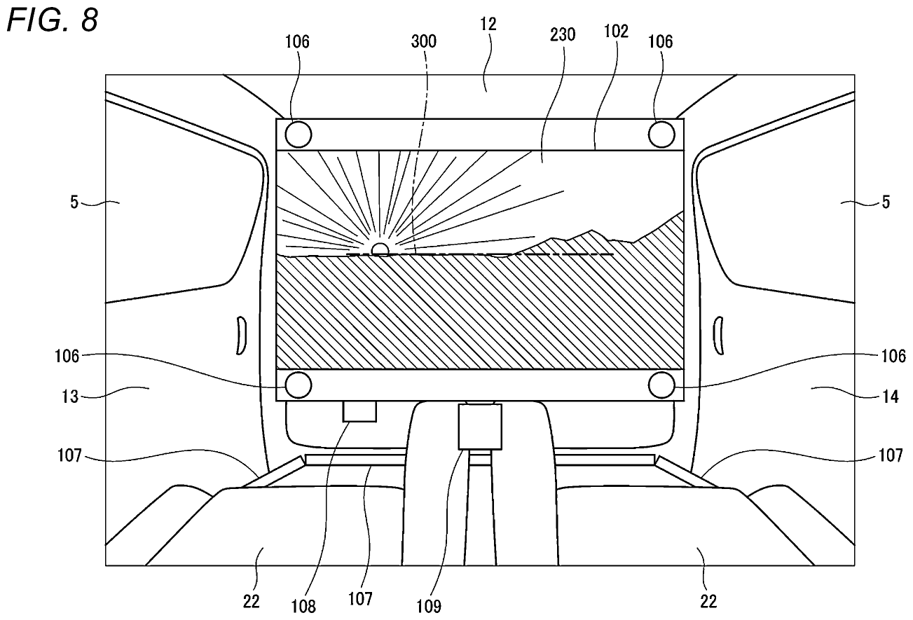

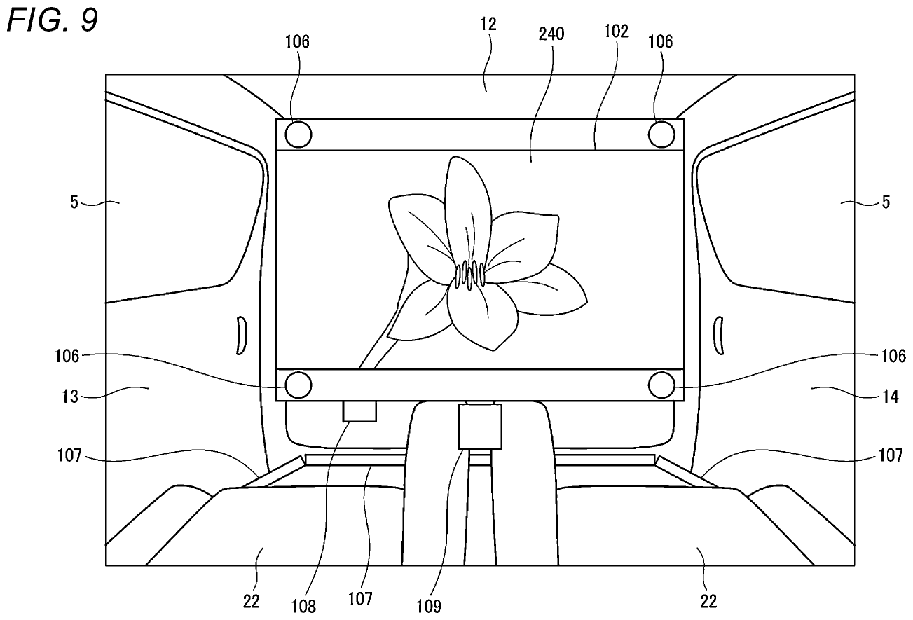

FIG. 5 is a graph illustrating an example of a change in the transmittance of the transparent display 102 in each phase according to Embodiment 1. In the graph illustrated in FIG. 5, a horizontal axis represents time, a vertical axis represents transmittance, and a thick line 201 represents change in transmittance. FIG. 6 is a diagram illustrating a first example of video content displayed on the transparent display 102 in a first phase according to Embodiment 1. FIG. 7 is a diagram illustrating a second example of the video content displayed on the transparent display 102 in the first phase according to Embodiment 1. FIG. 8 is a diagram illustrating a first example of the video content displayed on the transparent display 102 in a third phase according to Embodiment 1. FIG. 9 is a diagram illustrating a second example of the video content displayed on the transparent display 102 in the third phase according to Embodiment 1.

Next, with reference to FIGS. 5, 6, 7, 8, and 9, processing performed for supporting fatigue recovery of the user sitting in the rear seat 22 will be described in detail.

The video content is an image that changes over time, and has at least a first phase, a second phase that follows the first phase, a third phase that follows the second phase, and a fourth phase that follows the third phase. That is, when the video content is played, the video is displayed on the transparent display 102 in the order of the first phase, the second phase, the third phase, and the fourth phase. A light-shielding curtain (not illustrated) may be provided on a rear door window 5, and the light-shielding curtain may be closed when the video content is played. Alternatively, a light control film capable of changing the light transmittance may be provided on the rear door window 5, and the ECU 100 may automatically reduce the transmittance of the light control film when the video content is played. Accordingly, the rear chamber 24 can be darkened. Next, each phase will be described in detail.

### <First Phase>

In the first phase, a video that prompts the user (viewer) sitting in the rear seat 22 to relax is displayed on the transparent display 102. The transmittance of the transparent display 102 at an end of the first phase (second transmittance) may be smaller than the transmittance of the transparent display 102 at a beginning of the first phase (first transmittance). For example, in the first phase, as illustrated in FIG. 5, the transmittance of the transparent display 102 may change to decrease over time. Accordingly, a sight line of the user, which was directed to a scenery outside the vehicle through the front window 4, can be gradually guided to the video content displayed on the transparent display 102, and attention of the user can be smoothly directed to the video content.

The video that prompts relaxation may be a natural video including a forest and a river (hereinafter, referred to as a natural video 210) in first half of the first phase, as illustrated in FIG. 6. By displaying such a natural video 210, tension of the user can be alleviated, and the user can be prompted to relax. The video that prompts relaxation may be a video of the setting sun sinking into a horizon line or a horizontal line (hereinafter, referred to as a “setting sun video 220”) in second half of the first phase, as illustrated in FIG. 7. By displaying such a setting sun video 220, the user can be made aware of an end of active daytime, and the user can be prompted to relax.

The setting sun video 220 may have a horizon line or a horizontal line along the longitudinal direction of the rectangular transparent display 102. Further, the setting sun video 220 may include a circular light-emitting portion (setting sun) that is partially in contact with the horizon line or the horizontal line. The setting sun video 220 may be configured such that, when viewed from the user sitting in the rear seat 22, the horizon line or the horizontal line in the setting sun video 220 coincides with or is parallel to a boundary line 300 between the front window 4 and a dashboard 7.

Accordingly, the scenery outside the vehicle seen through the front window 4 above the boundary line 300 overlaps with an empty portion above the horizon line or the horizontal line in the setting sun video 220, and the dashboard 7 below the boundary line 300 overlaps with a ground or sea portion below the horizon line or the horizontal line in the setting sun video 220. Typically, the ground or sea portion below the horizon line or the horizontal line in the setting sun video 220 is darker than the empty portion above the horizon line or the horizontal line in the setting sun video 220, and thus the dashboard 7 is less visible through the transparent display 102. Therefore, a sense of incongruity felt by the user due to the overlap between the video content displayed on the transparent display 102 and the scenery seen through the transparent display 102 can be reduced. In addition, the attention of the user, which was directed to the scenery outside the vehicle seen through the front window 4, can be smoothly guided to the video content displayed on the transparent display 102.

In the first phase, when the natural video 210 is displayed, sound corresponding to the natural video 210 is output from the speaker 106, the light-emitting unit 107 emits light having a light color and/or a light intensity corresponding to the natural video 210, and an aroma corresponding to the natural video 210 is generated from the aroma generation unit 108. Further, in the first phase, when the setting sun video 220 is displayed, sound corresponding to the setting sun video 220 is output from the speaker 106, the light-emitting unit 107 emits light having a light color and/or a light intensity corresponding to the setting sun video 220, and an aroma corresponding to the setting sun video 220 is generated from the aroma generation unit 108. Accordingly, the user is prompted to relax not only through sight but also through hearing and smell.

### <Second Phase>

In the second phase, a video that prompts the user (viewer) sitting in the rear seat 22 to sleep (that is, guiding to sleep) is displayed on the transparent display 102. The video that prompts sleep may be, for example, a video having a relatively low brightness. Alternatively, in the second phase, no video content may be displayed on the transparent display 102.

An average value of the transmittance of the transparent display 102 during the first phase (first average transmittance) may be greater than an average value of the transmittance of the transparent display 102 during the second phase (second average transmittance). In other words, the average value of the transmittance of the transparent display 102 during the second phase (second average transmittance) may be smaller than the average value of the transmittance of the transparent display 102 during the first phase (first average transmittance). For example, the transmittance of the transparent display 102 in the second phase may be a minimum value within a range that can be set as the transmittance. Accordingly, in the second phase, an interior of the rear chamber 24 is relatively dark, and thus the user relaxed in the first phase can be guided to sleep.

In the second phase, sound corresponding to the video that prompts sleep is output from the speaker 106, the light-emitting unit 107 emits light having a light color and/or a light intensity corresponding to the video that prompts sleep, and an aroma corresponding to the video that prompts sleep is generated from the aroma generation unit 108. Alternatively, in the second phase, no sound may be output from the speaker 106, and no light may be emitted from the light-emitting unit 107. Accordingly, the user is prompted to sleep not only through sight but also through hearing and smell.

### <Third Phase>

In the third phase, a video that prompts the user (viewer) sitting in the rear seat 22 to awaken is displayed on the transparent display 102. The transmittance of the transparent display 102 in the third phase may be a third transmittance that is smaller than the first transmittance. Further, the third transmittance may be equal to the second transmittance. For example, the transmittance of the transparent display 102 in the third phase may be the minimum value within the range that can be set as the transmittance.

The video that prompts awakening may be a video of the morning sun rising above the horizon line or the horizontal line (hereinafter, referred to as a morning sun video 230) in first half of the third phase, as illustrated in FIG. 8. By displaying such a morning sun video 230, the user can be made aware of a start of active daytime, and the user can be prompted to awaken. The video that prompts awakening may be a video including a single flower (hereinafter, referred to as a flower video 240) in second half of the third phase, as illustrated in FIG. 9. By displaying such a flower video 240, the attention of the user can be drawn and the user can be prompted to awaken.

The morning sun video 230 may have a horizon line or a horizontal line along the longitudinal direction of the rectangular transparent display 102. Further, the morning sun video 230 may include a circular light-emitting portion (morning sun) that is partially in contact with the horizon line or the horizontal line. The morning sun video 230 may be configured such that, when viewed from the user sitting in the rear seat 22, the horizon line or the horizontal line in the morning sun video 230 coincides with or is parallel to the boundary line 300 between the front window 4 and the dashboard 7.

Accordingly, the scenery outside the vehicle seen through the front window 4 above the boundary line 300 overlaps with the empty portion above the horizon line or the horizontal line in the morning sun video 230, and the dashboard 7 below the boundary line 300 overlaps the ground or sea portion below the horizon line or the horizontal line in the morning sun video 230. Typically, the ground or sea portion below the horizon line or the horizontal line in the morning sun video 230 is darker than the empty portion above the horizon line or the horizontal line in the morning sun video 230, and thus the dashboard 7 is less visible through the transparent display 102. Therefore, a sense of incongruity felt by the user due to the overlap between the video content displayed on the transparent display 102 and the scenery seen through the transparent display 102 can be reduced.

In the third phase, when the morning sun video 230 is displayed, sound corresponding to the morning sun video 230 is output from the speaker 106, the light-emitting unit 107 emits light having a light color and/or a light intensity corresponding to the morning sun video 230, and an aroma corresponding to the morning sun video 230 is generated from the aroma generation unit 108. Further, in the third phase, when the flower video 240 is displayed, sound corresponding to the flower video 240 is output from the speaker 106, the light-emitting unit 107 emits light having a light color and/or a light intensity corresponding to the flower video 240, and an aroma corresponding to the flower video 240 is generated from the aroma generation unit 108. Accordingly, the user is prompted to awaken not only through sight but also through hearing and smell.

### <Fourth Phase>

In the fourth phase, a video that does not prompt the user (viewer) sitting in the rear seat 22 to at least relax, sleep, or awaken is displayed on the transparent display 102. The video displayed in the fourth phase may be, for example, a video having a relatively high brightness. Alternatively, in the fourth phase, no video content may be displayed on the transparent display 102.

The transmittance of the transparent display 102, after a certain period of time has passed from a start of the fourth phase, may be a fourth transmittance that is greater than the third transmittance. That is, the fourth transmittance may be a relatively high transmittance. For example, in the fourth phase, as illustrated in FIG. 5, the transmittance of the transparent display 102 may change to increase over time. Accordingly, the line of sight of the user which was directed to the video content displayed on the transparent display 102 can be gradually guided to the scenery outside the vehicle through the front window 4, and the attention of the user can be smoothly directed to the scenery outside the vehicle.

An average value of the transmittance of the transparent display 102 during the fourth phase (third average transmittance) may be greater than an average value of the transmittance of the transparent display 102 during the third phase (fourth average transmittance). For example, as illustrated in FIG. 5, the transmittance of the transparent display 102 in the fourth phase increases over time, and finally, the transmittance may be a maximum value within the range that can be set as the transmittance. Accordingly, since the transmittance of the transparent display 102 increases, the line of sight of the user, which was directed to the video content in the third phase can be gradually guided to the scenery outside the vehicle through the front window 4, and the attention of the user can be smoothly directed to the real scenery outside the vehicle.

In the fourth phase, no sound may be output from the speaker 106, no light may be emitted from the light-emitting unit 107, and no aroma may be generated from the aroma generation unit 108.

### <Transmittance>

When the rear chamber 24 is made completely dark and the outside of the vehicle cannot be viewed at all, there is a possibility that the user is likely to experience car sickness. Therefore, the minimum value of the transmittance of the transparent display 102 may be greater than 0. That is, the transparent display 102 may be configured not to completely block light from the outside of the vehicle. The minimum value of the transmittance of the transparent display 102 may be freely changed. For example, the minimum value of the transmittance of the transparent display 102 when a user who is likely to experience car sickness sits in the rear seat 22 may be set greater than the minimum value of the transmittance of the transparent display 102 when a user who is less likely to experience car sickness sits in the rear seat 22.

### Summary of Embodiment 1

The following techniques are disclosed from the above description of Embodiment 1.

### <Technique A1>

A vehicle 1 including: at least
a first wheel 3A coupled to a vehicle body 2;
a second wheel 3B coupled to the vehicle body 2;
a third wheel 3C coupled to the vehicle body 2; and
a fourth wheel 3D coupled to the vehicle body 2; and
the vehicle 1 being capable of traveling in a predetermined direction using the first wheel 3A, the second wheel 3B, the third wheel 3C, and the fourth wheel 3D, in which
the vehicle body 2 includes
   a floor surface portion 11 and a ceiling surface portion 12 disposed along the predetermined direction,
   a left side surface portion 13 that connects the floor surface portion 11 and the ceiling surface portion 12 and is disposed on a left side surface along the predetermined direction,
   a right side surface portion 14 that connects the floor surface portion 11 and the ceiling surface portion 12 and is disposed on a right side surface along the predetermined direction,
   a front surface portion 16 that connects the floor surface portion 11 and the ceiling surface portion 12 and is disposed on a front portion 15 with respect to the predetermined direction,
   a rear surface portion 18 that connects the floor surface portion 11 and the ceiling surface portion 12 and is disposed on a rear portion 17 with respect to the predetermined direction,
   at least one front seat 21 disposed on the floor surface portion 11, closer to the front surface portion 16 than the rear surface portion 18, and
   at least one rear seat 22 disposed on the floor surface portion 11, closer to the rear surface portion 18 than the front surface portion 16,
the front surface portion 16 includes a glass that allows an outside of the vehicle to be viewed in the predetermined direction from the front seat 21 (for example, a front window 4),
the vehicle body 2 further includes
   a transparent display 102 having a variable transmittance between the rear seat 22 and the front seat 21, and
   the outside of the vehicle is visible from the rear seat 22 through the transparent display 102 and the glass (for example, the front window 4),
   the transparent display 102 is set to play predetermined video content, the predetermined video content has at least a first phase, a second phase that follows the first phase, a third phase that follows the second phase, and a fourth phase that follows the third phase,
at a beginning of the first phase, the variable transmittance of the transparent display is a first transmittance, and
at an end of the first phase, the variable transmittance of the transparent display is a second transmittance that is smaller than the first transmittance.

### <Technique A2>

The vehicle 1 according to technique A1, in which
in the third phase of the predetermined video content, the variable transmittance of the transparent display is a third transmittance that is smaller than the first transmittance, and
the variable transmittance of the transparent display, after a certain period of time has passed from a start of the fourth phase, is a fourth transmittance that is greater than the third transmittance.

### <Technique A3>

The vehicle 1 according to technique A2, in which
the third transmittance is equal to the second transmittance.

### <Technique A4>

The vehicle 1 according to any one of techniques A1 to A3, in which
the first phase of the predetermined video content prompts a viewer to relax,
the second phase of the predetermined video content prompts the viewer to sleep,
the third phase of the predetermined video content prompts the viewer to awaken, and
the fourth phase of the predetermined video content does not prompt the viewer to at least relax, sleep, or awaken.

### <Technique A5>

The vehicle 1 according to any one of techniques A1 to A4, in which
a first average transmittance of the variable transmittance of the transparent display 102, averaged in the first phase of the predetermined video content, is greater than a second average transmittance of the variable transmittance of the transparent display 102, averaged in the second phase of the predetermined video content.

### <Technique A6>

The vehicle 1 according to any one of techniques A1 to A4, in which
a third average transmittance of the variable transmittance of the transparent display 102, averaged in the fourth phase of the predetermined video content, is greater than a fourth average transmittance of the variable transmittance of the transparent display 102, averaged in the third phase of the predetermined video content.

### <Technique A7>

The vehicle 1 according to any one of techniques A1 to A6, in which
the transparent display 102 includes at least a self-emissive display 103 and a sheet whose light transmittance is variable (for example, a light control film 104).

### <Technique A8>

The vehicle 1 according to any one of techniques A1 to A7, further including:
a front chamber 23 in which the front seat 21 is disposed;
a rear chamber 24 in which the rear seat 22 is disposed;
a partition wall 31 provided to partition the front chamber 23 and the rear chamber 24 and on which the transparent display 102 is disposed; and
a light-emitting unit 107 disposed on at least one of a partition wall rear chamber side surface portion 32 of the partition wall 31 on a rear chamber 24 side, the floor surface portion 11 in contact with the rear chamber 24, the ceiling surface portion 12 in contact with the rear chamber 24, the rear surface portion 18 in contact with the rear chamber 24, the left side surface portion 13 in contact with the rear chamber 24, or the right side surface portion 14 in contact with the rear chamber 24, and configured to adjust a light color and a light intensity, in which
the light color and/or the light intensity of the light-emitting unit 107 changes in response to the predetermined video content and passage of time of the predetermined video content.

### <Technique A9>

The vehicle 1 according to any one of techniques A1 to A8, further including:
an aroma generation unit 108 configured to generate an aroma, in which
the aroma generated by the aroma generation unit 108 changes in response to the predetermined video content and the passage of time of the predetermined video content.

### <Technique B1>

A vehicle 1 including: at least
a first wheel 3A coupled to a vehicle body 2;
a second wheel 3B coupled to the vehicle body 2;
a third wheel 3C coupled to the vehicle body 2; and
a fourth wheel 3D coupled to the vehicle body 2; and
the vehicle 1 being capable of traveling in a predetermined direction using the first wheel 3A, the second wheel 3B, the third wheel 3C, and the fourth wheel 3D, in which
the vehicle body 2 includes
   a floor surface portion 11 and a ceiling surface portion 12 disposed along the predetermined direction,
   a left side surface portion 13 that connects the floor surface portion 11 and the ceiling surface portion 12 and is disposed on a left side surface along the predetermined direction,
   a right side surface portion 14 that connects the floor surface portion 11 and the ceiling surface portion 12 and is disposed on a right side surface along the predetermined direction,
   a front surface portion 16 that connects the floor surface portion 11 and the ceiling surface portion 12 and is disposed on a front portion 15 with respect to the predetermined direction,
   a rear surface portion 18 that connects the floor surface portion 11 and the ceiling surface portion 12 and is disposed on a rear portion 17 with respect to the predetermined direction,
   at least one front seat 21 disposed on the floor surface portion 11, closer to the front surface portion 16 than the rear surface portion 18, and
   at least one rear seat 22 disposed on the floor surface portion 11, closer to the rear surface portion 18 than the front surface portion 16,
the front surface portion 16 includes a glass that allows an outside of the vehicle to be viewed in the predetermined direction from the front seat 21 (for example, a front window 4), and
the vehicle body 2 further includes
   a rectangular transparent display 102 between the rear seat 22 and the front seat 21, and
   the transparent display 102 is provided such that a longitudinal direction of the rectangle is along a horizontal direction,
   the outside of the vehicle is visible from the rear seat 22 through the transparent display 102 and the glass (for example, the front window 4),
   the transparent display 102 is set to play predetermined video content,
   the predetermined video content has at least a first phase, a second phase that follows the first phase, and a third phase that follows the second phase, and
at least a part of the first phase includes a video having a horizon line or a horizontal line along the longitudinal direction of the rectangle.

### <Technique B2>

The vehicle 1 according to technique B1, in which
the video having the horizon line or the horizontal line displays a circular light-emitting portion that is partially in contact with the horizon line or the horizontal line.

### <Technique B3>

The vehicle 1 according to technique B2, in which
the circular light-emitting portion in the video having the horizon line or the horizontal line represents the sun.

### <Technique B4>

The vehicle 1 according to any one of techniques B1 to B3, in which
the first phase of the predetermined video content prompts a viewer to relax,
the second phase of the predetermined video content prompts the viewer to sleep, and
the third phase of the predetermined video content prompts the viewer to awaken.

### <Technique B5>

The vehicle 1 according to any one of techniques B1 to B4,
at least a part of the third phase includes a video having a horizon line or a horizontal line along the longitudinal direction of the rectangle, and
the video having the horizon line or the horizontal line displays a circular light-emitting portion that is partially in contact with the horizon line or the horizontal line.

### <Technique B6>

The vehicle 1 according to technique B5, in which
the circular light-emitting portion in the video having the horizon line or the horizontal line represents the sun.

### <Technique B7>

The vehicle 1 according to any one of techniques B1 to B6, in which
the transparent display 102 includes at least a self-emissive display 103 and a sheet whose light transmittance is variable (for example, a light control film).

### <Technique B8>

The vehicle 1 according to any one of techniques B1 to B7, further including:
a front chamber 23 in which the front seat 21 is disposed;
a rear chamber 24 in which the rear seat 22 is disposed;
a partition wall 31 provided to partition the front chamber 23 and the rear chamber 24 and on which the transparent display 102 is disposed; and
a light-emitting unit 107 disposed on at least one of a partition wall rear chamber side surface portion 32 of the partition wall 31 on a rear chamber 24 side, the floor surface portion 11 in contact with the rear chamber 24, the ceiling surface portion 12 in contact with the rear chamber 24, the rear surface portion 18 in contact with the rear chamber 24, the left side surface portion 13 in contact with the rear chamber 24, or the right side surface portion 14 in contact with the rear chamber 24, and configured to adjust a light color and a light intensity, in which
the light color and/or the light intensity of the light-emitting unit 107 changes in response to the predetermined video content and passage of time of the predetermined video content.

### <Technique B9>

The vehicle 1 according to any one of techniques B1 to B8, further including:
an aroma generation unit 108 configured to generate an aroma, in which
the aroma generated by the aroma generation unit 108 changes in response to the predetermined video content and the passage of time of the predetermined video content.

### Embodiment 2

In Embodiment 2, contents added or changed from the contents described in Embodiment 1 will be described. Therefore, unless otherwise specified, the contents of Embodiment 1 are entirely incorporated into Embodiment 2.

### <First Phase>

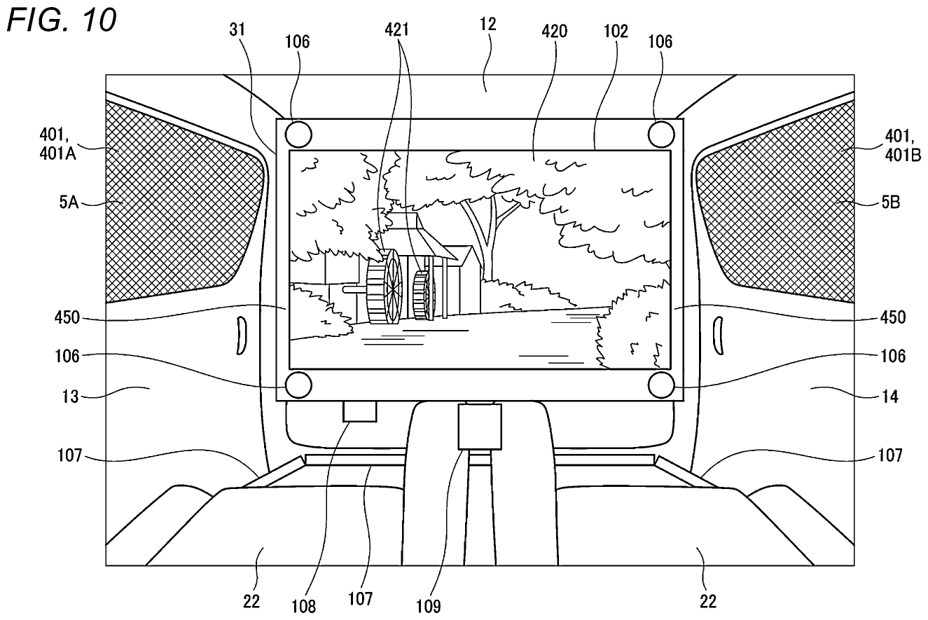

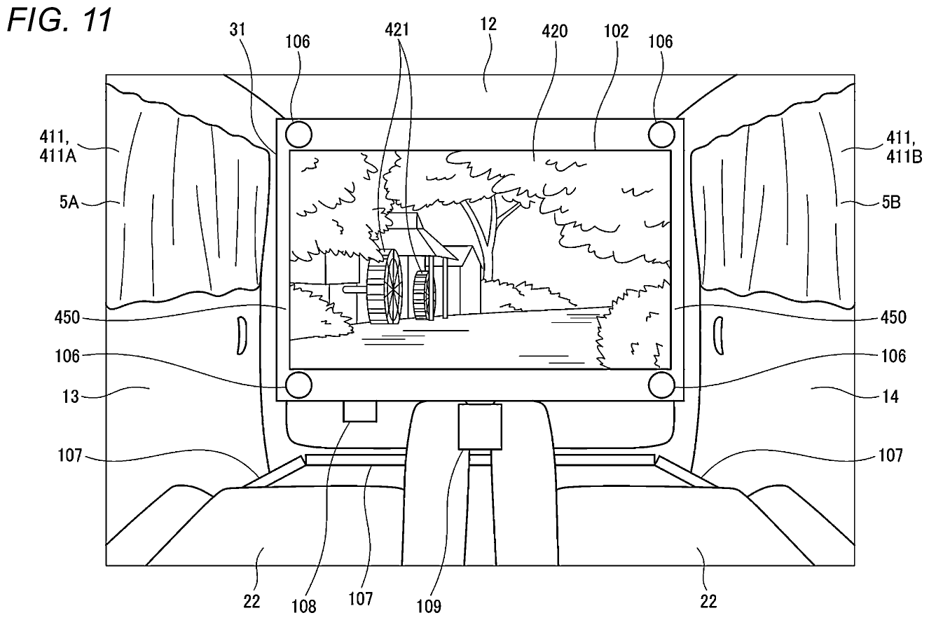

FIG. 10 is a diagram illustrating an example of video content displayed on the transparent display 102 in a first phase in a case in which a light control film 401 is provided on the rear door window 5 according to Embodiment 2. FIG. 11 is a diagram illustrating an example of video content displayed on the transparent display 102 in the first phase in a case in which a light-shielding curtain 411 is provided on the rear door window 5 according to Embodiment 2.

As illustrated in FIG. 10, the light control film 401 may be provided on the rear door window 5. In addition, a light control film 402 (see FIG. 1) may be provided on a rear window 6. When the first phase starts, the ECU 100 may control transmittances of the light control film 401 on the rear door window 5 and the light control film 402 on the rear window 6 to be lower than transmittances before the start of the first phase (for example, change the transmittances to a minimum value). Accordingly, the rear chamber 24 can be darkened.

Alternatively, as illustrated in FIG. 11, the light-shielding curtain 411 may be provided on the rear door window 5. In addition, a light-shielding curtain (not illustrated) may be provided on the rear window 6. When the first phase starts, the ECU 100 may automatically close the light-shielding curtain 411 on the rear door window 5 and the light-shielding curtain (not illustrated) on the rear window 6. Accordingly, the rear chamber 24 can be darkened.

After the rear chamber 24 is darkened in this manner, the ECU 100 outputs, from the speaker 106, audio that prompts a deep breath such as “please take a slow deep breath”, in at least a part of the first phase (for example, immediately after the start of the first phase).

Then, the ECU 100 displays a video that prompts relaxation on the transparent display 102 in the first phase. The video that prompts relaxation may be a video including an object that operates at a predetermined cycle, in addition to the natural video 210 and the setting sun video 220 described in Embodiment 1. The object that operates at a predetermined cycle may be a rotating water wheel. That is, in the first phase, a video including a water wheel 421 that rotates at a predetermined cycle (hereinafter, referred to as a “water wheel video 420”) as illustrated in FIG. 10 or FIG. 11 may be displayed as the video that prompts relaxation. The water wheel video 420 may be a live-action video or computer graphics (CG). The water wheel video 420 may be displayed after the natural video 210 described in Embodiment 1. However, the water wheel video 420 may be displayed at any timing in the first phase.

In this way, by outputting an announcement that prompts a deep breath and displaying the water wheel video 420 which includes the water wheel 421 rotating at a predetermined cycle, the user sitting in the rear seat 22 can be guided to take deep breaths at regular intervals. As a result, the user can be prompted to relax, and drowsiness of the user can be enhanced.

The object that operates at a predetermined cycle is not limited to the water wheel, and may also be, for example, a windmill, or waves that break at predetermined time intervals. That is, in the first phase, a video including a windmill rotating at a predetermined cycle (hereinafter, referred to as a windmill video) or a video including waves that break at predetermined time intervals (hereinafter, referred to as a wave video) may be displayed as the video that prompts relaxation. The windmill video or the wave video may be a live-action video or CG.

The video that prompts relaxation displayed in the first phase may be a video that does not focus on a specific object (for example, a natural scenery), as illustrated in FIG. 6 or FIG. 10. By displaying such a video that does not focus on a specific object, the user can be more easily relaxed, and the drowsiness of the user can be enhanced. The video that does not focus on a specific object may be a video shot at a wide angle.

### <Third Phase>

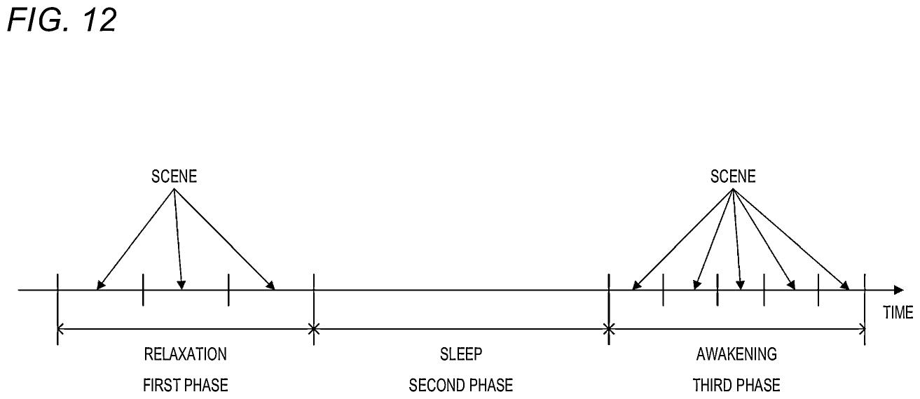

FIG. 12 is a diagram for explaining a time interval for scene switching in a third phase according to Embodiment 2.

As illustrated in FIG. 12, an average time interval for scene switching in the third phase (hereinafter, referred to as a second average time interval) may be shorter than an average time interval for scene switching in the first phase (hereinafter, referred to as a first average time interval). In other words, the average time interval for scene switching in the first phase (first average time interval) may be longer than the average time interval for scene switching in the third phase (second average time interval). As described above, in the third phase, by displaying video content in which scenes switch in a relatively short time, a strong visual stimulus can be provided to the user in the rear seat 22, prompting the user to awaken. The first average time interval may be a value obtained by dividing a total time of each scene in the first phase by the number of scenes included in the first phase. The second average time interval may be a value obtained by dividing a total time of each scene in the third phase by the number of scenes included in the third phase.

In at least a part of the third phase, the ECU 100 may output a bird tweet from the speaker 106. In this way, by outputting the bird tweet in the third phase, the user can be reminded of a morning image, and the user can be prompted to awaken.

The video that prompts awakening displayed in the third phase may be a video that focuses on a specific object (for example, a single flower) as illustrated in FIG. 9. By displaying such a video that focuses on a specific object, the user can more easily concentrate, and the user can be prompted to awaken. The video that focuses on a specific object may be a video captured by zooming in.

When the third phase starts or when the third phase ends, the ECU 100 may control the transmittances of the light control film 401 on the rear door window 5 and the light control film 402 on the rear window 6 to be higher than transmittances in a second phase (for example, change the transmittances to a maximum value). Accordingly, the rear chamber 24 can be brightened, and the user can be prompted to awaken.

Alternatively, when the third phase starts or when the third phase ends, the ECU 100 may control the light-shielding curtain 411 on the rear door window 5 and the light-shielding curtain (not illustrated) on the rear window 6 to open. Accordingly, the rear chamber 24 can be brightened, and the user can be prompted to awaken.

### <Light-Shielding Property of Rear Chamber>

As described in Embodiment 1, the partition wall 31 that partitions the front seat 21 and the rear seat 22 and the transparent display 102 disposed on the partition wall 31 are provided between the front seat 21 and the rear seat 22. As illustrated in FIG. 10 or FIG. 11, the transparent display 102 may be disposed to be accommodated in the partition wall 31. Hereinafter, a portion of the partition wall 31 other than the transparent display 102 will be referred to as an outer frame 450.

The user sitting in the rear seat 22 can view the outside of the vehicle through the transparent display 102 and the front window 4. The transparent display 102 has a variable light transmittance that can be changed between a first light transmittance and a second light transmittance that is greater than the first light transmittance. The variable light transmittance changes in response to the video content played on the transparent display 102 and passage of time of the video content.

The transparent display 102 includes at least the self-emissive display 103 and the sheet whose light transmittance is variable (light control film 104).

In the partition wall 31, an average transmittance in the portion other than the transparent display 102 (outer frame 450) (hereinafter, referred to as a third light transmittance) can be made smaller than the first light transmittance. That is, the third light transmittance of the outer frame 450 may be relatively small. Accordingly, light from the outside of the vehicle can be prevented from passing through the outer frame 450 and entering the rear chamber 24, and the rear chamber 24 can be darkened. The outer frame 450 may be made of light control glass. In this case, the ECU 100 may control the transmittance of the outer frame 450 (light control glass) to decrease when the first phase starts. Alternatively, the outer frame 450 may simply be made of a material having a high light-shielding property.

An average light transmittance in the rear surface portion 18 in contact with the rear chamber 24 (hereinafter, referred to as a fourth light transmittance) can be set smaller than the first light transmittance. For example, the fourth light transmittance of the rear window 6 may be relatively small. Accordingly, light from the outside of the vehicle can be prevented from passing through the rear window 6 and entering the rear chamber 24, and the rear chamber 24 can be darkened. When the light control film 402 is provided on the rear window 6, the ECU 100 may control the transmittance of the light control film 402 to decrease when the first phase starts. When the light-shielding curtain (not illustrated) is provided on the rear window 6, the ECU 100 may control the light-shielding curtain to close when the first phase starts. The light-shielding curtain may be manually closed. Alternatively, a sheet having a high light-shielding property may be attached to the rear window 6.

An average light transmittance in the left side surface portion 13 in contact with the rear chamber 24 (hereinafter, referred to as a fifth light transmittance) can be set smaller than the first light transmittance. For example, the fifth light transmittance of a rear door window 5A may be relatively small. Accordingly, light from the outside of the vehicle can be prevented from passing through the rear door window 5A and entering the rear chamber 24, and the rear chamber 24 can be darkened. When a light control film 401A is provided on the rear door window 5A, the ECU 100 may control the transmittance of the light control film 401A to decrease when the first phase starts. When a light-shielding curtain 411A is provided on the rear door window 5A, the ECU 100 may control the light-shielding curtain 411A to close when the first phase starts. The light-shielding curtain 411A may be manually closed. Alternatively, a sheet having a high light-shielding property may be attached to the rear door window 5A.

An average light transmittance in the right side surface portion 14 in contact with the rear chamber 24 (hereinafter, referred to as a sixth light transmittance) can be set smaller than the first light transmittance. For example, the sixth light transmittance of a rear door window 5B may be relatively small. Accordingly, light from the outside of the vehicle can be prevented from passing through the rear door window 5B and entering the rear chamber 24, and the rear chamber 24 can be darkened. When a light control film 401B is provided in the rear door window 5B, the ECU 100 may control the transmittance of the light control film 401B to decrease when the first phase starts. When the light-shielding curtain 411B is provided on the rear door window 5B, the ECU 100 may control the light-shielding curtain 411B to close when the first phase starts. The light-shielding curtain 411B may be manually closed. Alternatively, a sheet having a high light-shielding property may be attached to the rear door window 5B.

### Summary of Embodiment 2

The following techniques are disclosed from the above description of Embodiment 2.

### <Technique C1>

A vehicle 1 including: at least
a first wheel 3A coupled to a vehicle body 2;
a second wheel 3B coupled to the vehicle body 2;
a third wheel 3C coupled to the vehicle body 2; and
a fourth wheel 3D coupled to the vehicle body 2; and
the vehicle 1 being capable of traveling in a predetermined direction using the first wheel 3A, the second wheel 3B, the third wheel 3C, and the fourth wheel 3D, in which
the vehicle body 2 includes
   a floor surface portion 11 and a ceiling surface portion 12 disposed along the predetermined direction,
   a left side surface portion 13 that connects the floor surface portion 11 and the ceiling surface portion 12 and is disposed on a left side surface along the predetermined direction,
   a right side surface portion 14 that connects the floor surface portion 11 and the ceiling surface portion 12 and is disposed on a right side surface along the predetermined direction,
   a front surface portion 16 that connects the floor surface portion 11 and the ceiling surface portion 12 and is disposed on a front portion 15 with respect to the predetermined direction,
   a rear surface portion 18 that connects the floor surface portion 11 and the ceiling surface portion 12 and is disposed on a rear portion 17 with respect to the predetermined direction,
   at least one front seat 21 disposed on the floor surface portion 11, closer to the front surface portion 16 than the rear surface portion 18, and
   at least one rear seat 22 disposed on the floor surface portion 11, closer to the rear surface portion 18 than the front surface portion 16,
the front surface portion 16 includes a glass that allows an outside of the vehicle to be viewed in the predetermined direction from the front seat 21 (for example, a front window 4),
the vehicle body 2 further includes
   a transparent display 102 between the rear seat 22 and the front seat 21, and
   a speaker 106 that emits sound toward the rear seat 22,
the transparent display 102 and the speaker 106 are set to play predetermined video content and audio, respectively,
the predetermined video content has at least a first phase, a second phase that follows the first phase, and a third phase that follows the second phase, and
in at least a part of the first phase, the speaker 106 outputs audio that prompts a deep breath, and the transparent display 102 displays an object that operates at a predetermined cycle.

### <Technique C2>

The vehicle 1 according to technique C1, in which
the object that operates at a predetermined cycle is a rotating water wheel 421 or a windmill.

### <Technique C3>

The vehicle 1 according to technique C1, in which
the object that operates at a predetermined cycle is waves that break at predetermined time intervals.

### <Technique C4>

The vehicle 1 according to any one of techniques C1 to C3, in which
the first phase of the predetermined video content prompts a viewer to relax,
the second phase of the predetermined video content prompts the viewer to sleep, and
the third phase of the predetermined video content prompts the viewer to awaken.

### <Technique C5>

The vehicle 1 according to any one of techniques C1 to C4, further including:
a front chamber 23 in which the front seat 21 is disposed;
a rear chamber 24 in which the rear seat 22 is disposed;
a partition wall 31 provided to partition the front chamber 23 and the rear chamber 24 and on which the transparent display is disposed; and
a light-emitting unit 107 disposed on at least one of a partition wall rear chamber side surface portion 32 of the partition wall 31 on a rear chamber 24 side, the floor surface portion 11 in contact with the rear chamber 24, the ceiling surface portion 12 in contact with the rear chamber 24, the rear surface portion 18 in contact with the rear chamber 24, the left side surface portion 13 in contact with the rear chamber 24, or the right side surface portion 14 in contact with the rear chamber 24, and configured to adjust a light color and a light intensity, in which
the light color and/or the light intensity of the light-emitting unit 107 changes in response to the predetermined video content and passage of time of the predetermined video content.

### <Technique C6>

The vehicle 1 according to any one of techniques C1 to C5, further including:
an aroma generation unit 108 configured to generate an aroma, in which
the aroma generated by the aroma generation unit 108 changes in response to the predetermined video content and the passage of time of the predetermined video content.

### <Technique D1>

A vehicle 1 including: at least
a first wheel 3A coupled to a vehicle body 2;
a second wheel 3B coupled to the vehicle body 2;
a third wheel 3C coupled to the vehicle body 2; and
a fourth wheel 3D coupled to the vehicle body 2; and
the vehicle 1 being capable of traveling in a predetermined direction using the first wheel 3A, the second wheel 3B, the third wheel 3C, and the fourth wheel 3D, in which
the vehicle body 2 includes
   a floor surface portion 11 and a ceiling surface portion 12 disposed along the predetermined direction,
   a left side surface portion 13 that connects the floor surface portion 11 and the ceiling surface portion 12 and is disposed on a left side surface along the predetermined direction,
   a right side surface portion 14 that connects the floor surface portion 11 and the ceiling surface portion 12 and is disposed on a right side surface along the predetermined direction,
   a front surface portion 16 that connects the floor surface portion 11 and the ceiling surface portion 12 and is disposed on a front portion 15 with respect to the predetermined direction,
   a rear surface portion 18 that connects the floor surface portion 11 and the ceiling surface portion 12 and is disposed on a rear portion 17 with respect to the predetermined direction,
   at least one front seat 21 disposed on the floor surface portion 11, closer to the front surface portion 16 than the rear surface portion 18, and
   at least one rear seat 22 disposed on the floor surface portion 11, closer to the rear surface portion 18 than the front surface portion 16,
the front surface portion 16 includes a glass that allows an outside of the vehicle to be viewed in the predetermined direction from the front seat 21 (for example, a front window 4), and
the vehicle body 2 further includes
   a transparent display 102 between the rear seat 22 and the front seat 21, which has a variable light transmittance changeable between a first light transmittance and a second light transmittance that is greater than the first light transmittance,
the outside of the vehicle is visible from the rear seat 22 through the transparent display 102 and the glass, and
the variable light transmittance changes in response to video content played on the transparent display 102 and passage of time of the video content.

### <Technique D2>

The vehicle 1 according to technique D1, in which
the transparent display 102 includes at least a self-emissive display 103 and a sheet whose light transmittance is variable (for example, a light control film 104).

### <Technique D3>

The vehicle 1 according to technique D1 or D2, further including:
a front chamber 23 in which the front seat 21 is disposed and that is in contact with at least the front surface portion 16;
a rear chamber 24 in which the rear seat 22 is disposed and that is in contact with at least the rear surface portion 18; and
a partition wall 31 disposed between the front chamber 23 and the rear chamber 24, configured to partition the front chamber 23 and the rear chamber 24, and on which the transparent display 102 is disposed, in which
in the partition wall 31, an average light transmittance in a portion other than the transparent display 102 (for example, an outer frame 450) is a third light transmittance, and
the third light transmittance is set to be smaller than the first light transmittance.

### <Technique D4>

The vehicle 1 according to technique D3, in which
an average light transmittance in the rear surface portion 18 in contact with the rear chamber 24 is a fourth light transmittance, and
the fourth light transmittance is set to be smaller than the first light transmittance.

### <Technique D5>

The vehicle 1 according to technique D3 or D4, in which
an average light transmittance in the left side surface portion 13 in contact with the rear chamber 24 is a fifth light transmittance, and
the fifth light transmittance is set to be smaller than the first light transmittance.

### <Technique D6>

The vehicle 1 according to any one of technique D3 to D5, in which
an average light transmittance in the right side surface portion 14 in contact with the rear chamber 24 is a sixth light transmittance, and
the sixth light transmittance is set to be smaller than the first light transmittance.

### <Technique D7>

The vehicle 1 according to any one of techniques D3 to D6, further including:
a light-emitting unit 107 disposed on at least one of the partition wall 31 in contact with the rear chamber 24, the floor surface portion 11 in contact with the rear chamber 24, the ceiling surface portion 12 in contact with the rear chamber 24, the rear surface portion 18 in contact with the rear chamber 24, the left side surface portion 13 in contact with the rear chamber 24, or the right side surface portion 14 in contact with the rear chamber 24, and configured to adjust a light color and a light intensity, in which
the light color and/or the light intensity of the light-emitting unit 107 changes in response to video content played on the transparent display 102 and passage of time of the video content.

### <Technique D8>

The vehicle 1 according to techniques D3 to D7, further including:
an aroma generation unit 108 configured to generate an aroma, in which
the aroma generated by the aroma generation unit 108 changes in response to the video content played on the transparent display 102 and the passage of time of the video content.

### <Technique D9>

A transparent display 102 provided in a vehicle 1, in which
the vehicle 1 includes at least
a first wheel 3A coupled to a vehicle body 2,
a second wheel 3B coupled to the vehicle body 2,
a third wheel 3C coupled to the vehicle body 2, and
a fourth wheel 3D coupled to the vehicle body 2, and
the vehicle 1 is capable of traveling in a predetermined direction using the first wheel 3A, the second wheel 3B, the third wheel 3C, and the fourth wheel 3D,
the vehicle body 2 includes
   a floor surface portion 11 and a ceiling surface portion 12 disposed along the predetermined direction,
   a left side surface portion 13 that connects the floor surface portion 11 and the ceiling surface portion 12 and is disposed on a left side surface along the predetermined direction,
   a right side surface portion 14 that connects the floor surface portion 11 and the ceiling surface portion 12 and is disposed on a right side surface along the predetermined direction,
   a front surface portion 16 that connects the floor surface portion 11 and the ceiling surface portion 12 and is disposed on a front portion 15 with respect to the predetermined direction,
   a rear surface portion 18 that connects the floor surface portion 11 and the ceiling surface portion 12 and is disposed on a rear portion 17 with respect to the predetermined direction,
   at least one front seat 21 disposed on the floor surface portion 11, closer to the front surface portion 16 than the rear surface portion 18, and
   at least one rear seat 22 disposed on the floor surface portion 11, closer to the rear surface portion 18 than the front surface portion 16,
the front surface portion 16 includes a glass that allows an outside of the vehicle to be viewed in the predetermined direction from the front seat 21 (for example, a front window 4),
the transparent display 102 is disposed between the rear seat and the front seat of the vehicle body 2 such that an outside of the vehicle is visible from the rear seat through the transparent display and the glass, and has a variable light transmittance changeable between a first light transmittance and a second light transmittance that is greater than the first light transmittance, and
the variable light transmittance changes in response to played video content and passage of time of the video content.

### <Technique D10>

The transparent display 102 according to technique D9, including:
at least a self-emissive display 103 and a sheet whose light transmittance is variable (for example, a light control film 104).

### <Technique D11>

The transparent display 102 according to technique D9, in which
the vehicle 1 further includes
a front chamber 23 in which the front seat 21 is disposed and that is in contact with at least the front surface portion 16,
a rear chamber 24 in which the rear seat 22 is disposed and that is in contact with at least the rear surface portion 18, and
a partition wall disposed between the front chamber 23 and the rear chamber 24, configured to partition the front chamber 23 and the rear chamber 24, and on which the transparent display 102 is disposed, and
in the partition wall 31, an average light transmittance in a portion other than the transparent display 102 (for example, an outer frame 450) is a third light transmittance, and
the third light transmittance is set to be smaller than the first light transmittance.

### <Technique D12>

The transparent display 102 according to technique D11, in which
an average light transmittance in the rear surface portion 18 in contact with the rear chamber 24 is a fourth light transmittance, and
the fourth light transmittance is set to be smaller than the first light transmittance.

### <Technique D13>

The transparent display 102 according to technique D11 or D12, in which
an average light transmittance in the left side surface portion 13 in contact with the rear chamber 24 is a fifth light transmittance, and
the fifth light transmittance is set to be smaller than the first light transmittance.

### <Technique D14>

The transparent display 102 according to any one of techniques D11 to D13, in which
an average light transmittance in the right side surface portion 14 in contact with the rear chamber 24 is a sixth light transmittance, and
the sixth light transmittance is set to be smaller than the first light transmittance.

### <Technique D15>

The transparent display 102 according to any one of techniques D11 to D14, in which
the vehicle 1 includes
a light-emitting unit 107 disposed on at least one of the partition wall 31 in contact with the rear chamber 24, the floor surface portion 11 in contact with the rear chamber 24, the ceiling surface portion 12 in contact with the rear chamber 24, the rear surface portion 18 in contact with the rear chamber 24, the left side surface portion 13 in contact with the rear chamber 24, or the right side surface portion 14 in contact with the rear chamber 24, and is capable of adjusting a light color and a light intensity, and
the light color and/or the light intensity of the light-emitting unit 107 changes in response to video content played on the transparent display 102 and passage of time of the video content.

### <Technique D16>

The transparent display 102 according to any one of techniques D11 to D15, in which
the vehicle 1 includes
an aroma generation unit 108 that generates an aroma, and
the aroma generated by the aroma generation unit 108 changes in response to the video content played on the transparent display 102 and the passage of time of the video content.

### <Technique E1>

A vehicle 1 including: at least
a first wheel 3A coupled to a vehicle body 2;
a second wheel 3B coupled to the vehicle body 2;
a third wheel 3C coupled to the vehicle body 2; and
a fourth wheel 3D coupled to the vehicle body 2; and
the vehicle 1 being capable of traveling in a predetermined direction using the first wheel 3A, the second wheel 3B, the third wheel 3C, and the fourth wheel 3D, in which
the vehicle body 2 includes
   a floor surface portion 11 and a ceiling surface portion 12 disposed along the predetermined direction,
   a left side surface portion 13 that connects the floor surface portion 11 and the ceiling surface portion 12 and is disposed on a left side surface along the predetermined direction,
   a right side surface portion 14 that connects the floor surface portion 11 and the ceiling surface portion 12 and is disposed on a right side surface along the predetermined direction,
   a front surface portion 16 that connects the floor surface portion 11 and the ceiling surface portion 12 and is disposed on a front portion 15 with respect to the predetermined direction,
   a rear surface portion 18 that connects the floor surface portion 11 and the ceiling surface portion 12 and is disposed on a rear portion 17 with respect to the predetermined direction,
   at least one front seat 21 disposed on the floor surface portion 11, closer to the front surface portion 16 than the rear surface portion 18, and
   at least one rear seat 22 disposed on the floor surface portion 11, closer to the rear surface portion 18 than the front surface portion 16,
the front surface portion 16 includes a glass that allows an outside of the vehicle to be viewed in the predetermined direction from the front seat 21 (for example, a front window 4),
the vehicle body 2 further includes
   a transparent display 102 between the rear seat 22 and the front seat 21, and
   the transparent display 102 is set to play predetermined video content,
the predetermined video content has at least a first phase, a second phase that follows the first phase, and a third phase that follows the second phase, and
a first average time interval for scene switching in the first phase is longer than a second average time interval for scene switching in the third phase.

### <Technique E2>

The vehicle 1 according to technique E1, further including:
a speaker 106 that emits sound to the rear seat 22 is provided, and
the speaker 106 outputs a bird tweet in at least a part of the third phase.

### <Technique E3>

The vehicle 1 according to techniques 1 or E2, in which
the first phase of the predetermined video content prompts a viewer to relax,
the second phase of the predetermined video content prompts the viewer to sleep, and
the third phase of the predetermined video content prompts the viewer to awaken.

### <Technique E4>

The vehicle 1 according to any one of techniques E1 to E3, further including:
a front chamber 23 in which the front seat 21 is disposed;
a rear chamber 24 in which the rear seat 22 is disposed;
a partition wall 31 provided to partition the front chamber 23 and the rear chamber 24 and on which the transparent display 102 is disposed; and
a light-emitting unit 107 disposed on at least one of a partition wall rear chamber side surface portion 32 of the partition wall 31 on a rear chamber 24 side, the floor surface portion 11 in contact with the rear chamber 24, the ceiling surface portion 12 in contact with the rear chamber 24, the rear surface portion 18 in contact with the rear chamber 24, the left side surface portion 13 in contact with the rear chamber 24, or the right side surface portion 14 in contact with the rear chamber 24, and configured to adjust a light color and a light intensity, in which
the light color and/or the light intensity of the light-emitting unit 107 changes in response to the predetermined video content and passage of time of the predetermined video content.

### <Technique E5>

The vehicle 1 according to any one of techniques E1 to E4, further including:
an aroma generation unit 108 configured to generate an aroma, in which
the aroma generated by the aroma generation unit 108 changes in response to the predetermined video content and the passage of time of the predetermined video content.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, constituent elements in the embodiments described above may be freely combined without departing from the gist of the invention.

The present application is based on Japan patent applications (Japanese Patent Application No. 2022-191768 and Japanese Patent Application No. 2022-191769) filed on Nov. 30, 2022, Japanese patent applications (Japanese Patent Application No. 2023-048200, Japanese Patent Application No. 2023-048201, and Japanese Patent Application No. 2023-048202 filed on Mar. 24, 2023, and the contents of which are incorporated herein by reference.

### INDUSTRIAL APPLICABILITY

The technique of the present disclosure is useful for achieving a vehicle that allows a passenger to spend time more comfortably.

### CROSS-REFERENCE TO RELATED APPLICATIONS

This is a continuation of International Application No. PCT/JP2023/032043 filed on Aug. 31, 2023, and claims priority from Japanese Patent Application No. 2022-191768 filed on Nov. 30, 2022, the entire content of which is incorporated herein by reference.

What is claimed is:

1. A vehicle comprising: at least
a vehicle body;
a first wheel coupled to the vehicle body;
a second wheel coupled to the vehicle body;
a third wheel coupled to the vehicle body; and
a fourth wheel coupled to the vehicle body; and
the vehicle is capable of traveling in a predetermined direction using the first wheel, the second wheel, the third wheel, and the fourth wheel, wherein
the vehicle body includes
a floor surface portion and a ceiling surface portion disposed along the predetermined direction,
a left side surface portion that connects the floor surface portion and the ceiling surface portion and is disposed on a left side surface along the predetermined direction,
a right side surface portion that connects the floor surface portion and the ceiling surface portion and is disposed on a right side surface along the predetermined direction,
a front surface portion that connects the floor surface portion and the ceiling surface portion and is disposed on a front portion with respect to the predetermined direction,
a rear surface portion that connects the floor surface portion and the ceiling surface portion and is disposed on a rear portion with respect to the predetermined direction,
at least one front seat disposed on the floor surface portion, closer to the front surface portion than the rear surface portion, and
at least one rear seat disposed on the floor surface portion, closer to the rear surface portion than the front surface portion,
the front surface portion includes a glass that allows an outside of the vehicle to be viewed in the predetermined direction from the front seat,
the vehicle body further includes a transparent display having a variable transmittance between the rear seat and the front seat,
the outside of the vehicle is visible from the rear seat through the transparent display and the glass,
the transparent display is set to play predetermined video content,
the predetermined video content has at least a first phase, a second phase that follows the first phase, a third phase that follows the second phase, and a fourth phase that follows the third phase,
the variable transmittance of the transparent display at a beginning of the first phase is a first transmittance, and
the variable transmittance of the transparent display at an end of the first phase is a second transmittance that is smaller than the first transmittance.

2. The vehicle according to claim 1, wherein
in the third phase of the predetermined video content, the variable transmittance of the transparent display is a third transmittance that is smaller than the first transmittance, and
after a certain period of time has passed from a start of the fourth phase, the variable transmittance of the transparent display is a fourth transmittance that is greater than the third transmittance.

3. The vehicle according to claim 2, wherein
the third transmittance is equal to the second transmittance.

4. The vehicle according to claim 1, wherein
the first phase of the predetermined video content prompts a viewer to relax,
the second phase of the predetermined video content prompts the viewer to sleep,
the third phase of the predetermined video content prompts the viewer to awaken, and
the fourth phase of the predetermined video content does not prompt the viewer to at least relax, sleep, or awaken.

5. The vehicle according to claim 1, wherein
an average value of the variable transmittance of the transparent display in the first phase of the predetermined video content is set as a first average transmittance,
an average value of the variable transmittance of the transparent display in the second phase of the predetermined video content is set as a second average transmittance, and
the first average transmittance is greater than the second average transmittance.

6. The vehicle according to claim 1, wherein
an average value of the variable transmittance of the transparent display in the fourth phase of the predetermined video content is set as a third average transmittance,
an average value of the variable transmittance of the transparent display in the third phase of the predetermined video content is set as a fourth average transmittance, and
the third average transmittance is greater than the fourth average transmittance.

7. The vehicle according to claim 1, wherein
the transparent display includes at least a self-emissive display and a sheet whose light transmittance is variable.

8. The vehicle according to claim 1, further comprising:
a front chamber in which the front seat is disposed;
a rear chamber in which the rear seat is disposed;
a partition wall provided to partition the front chamber and the rear chamber and on which the transparent display is disposed; and
a light-emitting unit disposed on at least one of a partition wall rear chamber side surface portion of the partition wall on a rear chamber side, the floor surface portion in contact with the rear chamber, the ceiling surface portion in contact with the rear chamber, the rear surface portion in contact with the rear chamber, the left side surface portion in contact with the rear chamber, or the right side surface portion in contact with the rear chamber, and configured to adjust a light color and a light intensity, wherein
the light color or the light intensity of the light-emitting unit changes in response to the predetermined video content and passage of time of the predetermined video content.

9. The vehicle according to claim 1, further comprising:
an aroma generation unit that generates an aroma, wherein
the aroma generated by the aroma generation unit changes in response to the predetermined video content and passage of time of the predetermined video content.
